(19) United States
(12) Patent Application Publication
(10) Pub. No.: US 2015/0347912 A1
(43) Pub. Date: Dec. 3, 2015

(54) ACTIVITY TRACKING BASED RECOMMENDATION

(71) Applicants: Alexandar Rodzevski, Malmo (SE); Jonas Gustavsson, Lund (SE)

(72) Inventors: Alexandar Rodzevski, Malmo (SE); Jonas Gustavsson, Lund (SE)

(73) Assignee: SONY CORPORATION, Tokyo (JP)

(21) Appl. No.: 14/287,387

(22) Filed: May 27, 2014

(51) Int. Cl. G06N 5/04; H04L 29/08; G01C 21/00; G01P 15/02; G01P 3/00

(52) U.S. Cl. CPC G06N 5/047; G01P 15/02; G01P 3/00; G01C 21/00; H04L 67/22

(57) ABSTRACT

A device may include a memory configured to store a first number of applications, and a sensor configured to detect information associated with an activity being performed by a user of the device. The device may also include processing logic configured to receive the information from the at least one sensor and identify the activity being performed by the user based on the received information. The processing logic may also identify an application based on the activity, and output a message to the user identifying the application.

### TECHNICAL FIELD OF THE INVENTION

The invention relates generally to tracking a user's activity and, more particularly, to providing recommendations to the user based on the user's activity.

### DESCRIPTION OF RELATED ART

Computer, communication and entertainment devices, such as personal computers (PCs), lap top computers, mobile terminals, smart phones, personal digital assistants (PDAs), etc., often include applications or sensors that enable the device to track or monitor a user's activity. For example, an application stored on a smart phone may track the distance that a user has walked during a particular period of time, songs that a user has listened to over the last few days, etc.

### SUMMARY

According to one aspect, a device is provided. The device includes a memory configured to store a first plurality of applications, and at least one sensor configured to detect information associated with an activity being performed by a user of the device. The device also includes processing logic configured to receive the information from the at least one sensor, identify the activity being performed by the user based on the received information, identify at least one application based on the activity, and output a message to the user identifying the at least one application.

Additionally, when detecting information, the at least one sensor may be configured to detect information identifying at least one of movement, velocity, acceleration or orientation of the device, and wherein the processing logic may be configured to identify the activity being performed by the user based on the least one of the movement, velocity, acceleration or orientation.

Additionally, the processing logic may be configured to access a website or application store that provides access to a second plurality of applications, and when identifying the at least one application, the processing logic may be configured to identify the at least one application from the second plurality of applications.

Additionally, the processing logic may be further configured to determine whether the at least one application is included in the first plurality of applications, and output a link associated with executing the at least one application, in response to determining that the at least one application is included in the first plurality of applications.

Additionally, the processing logic may be further configured to determine whether the at least one application is included in the first plurality of applications, and output a link to a website or application store via which the at least one application is available, in response to determining that the at least one application is not included in the first plurality of applications.

Additionally, when identifying the activity being performed, the processing logic may be configured to match the information received from the at least one sensor to a first one of a plurality of stored patterns, and identify the activity corresponding to the first stored pattern.

Additionally, the processing logic may be further configured to identify a first category corresponding to the activity and when identifying the at least one application, the processing logic may be further configured to identify at least a first application in the first category.

Additionally, when identifying at least one application, the processing logic may be configured to identify a plurality of applications.

Additionally, the at least one application may comprise a first application, and the device further comprises user interface logic configured to receive a selection from the user corresponding to the first application, and the processing logic may be further configured to receive the selection from the user, and automatically provide purchase information to a website offering the first application.

Additionally, the processing logic may be further configured to identify context information associated with the device or the activity, and wherein when identifying the at least one application, the processing logic may be configured to identify the at least one application based on the context information.

Additionally, the context information may comprise at least one of a location of the device, a time of day, day of the week, or an environmental parameter associated with the device.

Additionally, the device may further comprise a touch screen display configured to display the message, wherein the message includes information inquiring whether the user would like to execute or download the at least one application.

Additionally, the activity may comprise a physical activity performed by the user.

Additionally, the device may comprise a mobile terminal.

According to another aspect, a method is provided. The method comprises detecting, by at least one sensor, information associated with an activity being performed by a user of a mobile device, receiving the information from the at least one sensor and identifying the activity being performed by the user based on the received information. The method also comprises identifying at least one application based on the activity, and outputting a message to the user identifying the at least one application.

Additionally, the detecting information may comprise detecting information identifying at least one of movement, velocity, acceleration or orientation of the mobile device, and wherein identifying the activity may comprise identifying the activity being performed by the user based on the least one of the movement, velocity, acceleration or orientation of the mobile device.

According to a further aspect, a non-transitory computer-readable medium having stored thereon sequences of instructions is provided. The instructions, when executed by at least one processor, cause the at least one processor receive, from at least one sensor, information associated with an activity being performed by a user of a device, identify the activity being performed by the user based on the received information, identify at least one application based on the activity, and output a message to the user identifying the at least one application.

Additionally, the information may comprise at least one of movement, velocity, acceleration or orientation of the device, and the instructions may further cause the at least one processor to access a website or application store that provides access to a plurality of applications, and when identifying the at least one application, the instructions cause the at least one processor to identify the at least one application from the plurality of applications.

Additionally, the received information may comprise at least one of movement, velocity, acceleration or orientation of the device, and wherein the instructions to identify the activity cause the at least one processor to identify the activity being performed by the user based on the least one of the movement, velocity, acceleration or orientation of the mobile device.

Additionally, the non-transitory computer-readable medium may further include instructions for causing the at least one processor to identify context information associated with the device or the activity, and wherein when identifying the at least one application, the instructions cause the at least once processor to identify the at least one application based on the context information.

### BRIEF DESCRIPTION OF THE DRAWINGS

Reference is made to the attached drawings, wherein elements having the same reference number designation may represent like elements throughout.

FIG. 1 is a diagram of an exemplary device in which methods and systems described herein may be implemented;

FIG. 2 is a functional block diagram of exemplary components implemented in the device of FIG. 1;

FIG. 3 is a block diagram of logic components implemented in the device of FIG. 2 according to an exemplary implementation;

FIG. 4 is a flow diagram illustrating exemplary processing associated with tracking a user's activity and providing recommendations to the user based on the activity;

FIG. 5A is a diagram illustrating an exemplary recommendation message provided via the user device of FIG. 1 in accordance with the processing of FIG. 4;

FIG. 5B is a diagram illustrating another exemplary recommendation message provided via the user device of FIG. 1 in accordance with the processing of FIG. 4;

FIG. 6 is a flow diagram illustrating exemplary processing associated with providing recommendations and obtaining an application based on a recommendation; and

FIG. 7 is a diagram illustrating an exemplary message provided via the user device of FIG. 1 in accordance with the processing of FIG. 6.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

### Exemplary System

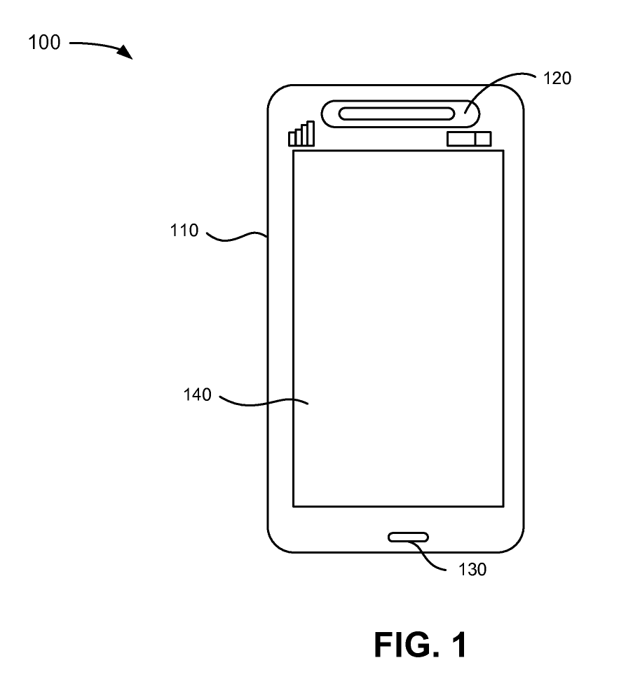

FIG. 1 is a diagram of an exemplary user device 100 in which methods and systems described herein may be implemented. In an exemplary implementation, user device 100 may be a mobile terminal. As used herein, the term “mobile terminal” may include a cellular radiotelephone, such as a smart phone; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. It should also be understood that systems and methods described herein may also be implemented in other devices that can track a user's activities and/or context. For example, user device 100 may include a personal computer (PC), a laptop computer, a tablet computer, a netbook, a media playing device (e.g., an MPEG audio layer 3 (MP3) player, a video game playing device, etc.), a global positioning system (GPS) device, etc.

Referring to FIG. 1, user device 100 may include a housing 110, a speaker 120, a microphone 130 and a display 140. Housing 110 may protect the components of user device 100 from outside elements. Speaker 120 may provide audible information to a user of user device 100. For example, speaker 120 may output music, ringtones, etc. Microphone 130 may receive audible information from the user of user device 100.

Display 140 may provide visual information to the user. For example, display 140 may provide information regarding recommendations for a user based on a user's current activity and/or context. Display 140 may also display incoming or outgoing telephone calls, electronic mail (e-mail), instant messages, short message service (SMS) messages, etc. Display 140 may further display information (not shown) regarding various applications stored in user device 100, such as an activity tracking program that allows user device 100 to track a user's activity and/or context, as well as other applications, such as an email program, a camera program/function, a phone book/contact list, an Internet browser used to access/download content (e.g., news or other information), music playing applications, navigation applications, games, etc.

In an exemplary implementation, display 140 may be a touch screen display device that allows a user to enter commands and/or information via a finger, a stylus, a mouse, a pointing device, or some other device. For example, display 140 may be a resistive touch screen, a capacitive touch screen, an optical touch screen, an infrared touch screen, a surface acoustic wave touch screen, or any other type of touch screen device that registers an input based on a contact with the screen.

Display 140 may also provide control buttons and/or a keypad, such as a graphical user interface (GUI) (not shown), that permit the user to interact with user device 100 to cause user device 100 to perform one or more operations, such as executing an application, download an application, interact with an application, etc.

In an exemplary implementation, user device 100 may also include one or more sensors, processors, or other mechanisms and/or logic that monitor a user's activities and context, evaluate the user's activities and context, and provide recommendations for applications that the user may wish to interact with, download and/or purchase based on the evaluation, as described in detail below.

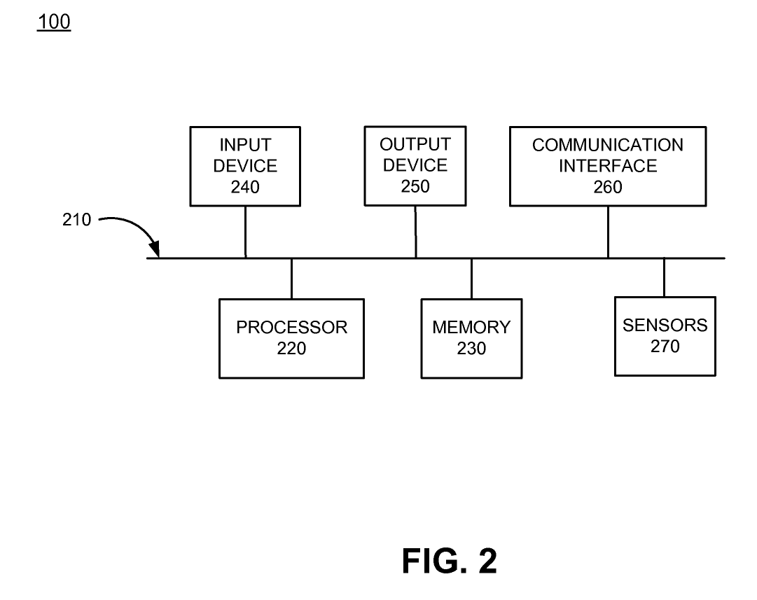

FIG. 2 is a diagram illustrating components of user device 100 according to an exemplary implementation. User device 100 may include bus 210, processor 220, memory 230, input device 240, output device 250, communication interface 260 and sensors 270. Bus 210 permits communication among the components of user device 100. One skilled in the art would recognize that user device 100 may be configured in a number of other ways and may include other or different elements. For example, user device 100 may include one or more modulators, demodulators, encoders, decoders, etc., for processing data.

Processor 220 may include a processor, microprocessor, an application specific integrated circuit (ASIC), field programmable gate array (FPGA) or other processing logic. Processor 220 may execute software instructions/programs or data structures to control operation of user device 100.

Memory 230 may include a random access memory (RAM) or another type of dynamic storage device that stores information and instructions for execution by processor 220; a read only memory (ROM) or another type of static storage device that stores static information and instructions for use by processor 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processor 220. Instructions used by processor 220 may also, or alternatively, be stored in another type of computer-readable medium accessible by processor 220. A computer-readable medium may include one or more memory devices.

Input device 240 may include mechanisms that permit an operator to input information to user device 100, such as microphone 130, a keypad, control buttons, a keyboard (e.g., a QWERTY keyboard, a Dvorak keyboard, etc.), a gesture-based device, an optical character recognition (OCR) based device, a joystick, a touch-based device, a virtual keyboard, a speech-to-text engine, a mouse, a pen, voice recognition and/or biometric mechanisms, etc. In an exemplary implementation, display 140 may be a touch screen display that acts as an input device.

Output device 250 may include one or more mechanisms that output information to the user, including a display, such as display 140, a printer, one or more speakers, such as speaker 120, etc. As described above, in an exemplary implementation, display 140 may be a touch screen display. In such an implementation, display 140 may function as both an input device and an output device.

Communication interface 260 may include a transceiver that enables user device 100 to communicate with other devices and/or systems. For example, communication interface 260 may include a modem or an Ethernet interface to a LAN. Communication interface 260 may also include mechanisms for communicating via a network, such as a wireless network. For example, communication interface 260 may include one or more radio frequency (RF) transmitters, receivers and/or transceivers and one or more antennas for transmitting and receiving RF data via a network.

Sensors 270 may include one or more sensors that monitor parameters associated with user device 100. For example, sensors 270 may include motion sensors, velocity sensors, accelerometers, gyroscopes (also referred to herein as gyros), a global positioning system (GPS), etc., that detect the velocity, acceleration, orientation, location, direction of travel, etc., of user device 100. Sensors 270 may also include sensors that detect environmental parameters associated with an environment in which user device 100 is located, such as temperature, humidity, light levels, etc.

User device 100 may provide a platform that detects a user's current activity and context, evaluates the user's activity and context and provides recommendations to the user regarding applications that may be of interest to the user. User device 100 may perform these operations in response to processor 220 executing sequences of instructions contained in a computer-readable medium, such as memory 230. Such instructions may be read into memory 230 from another computer-readable medium via, for example, and communication interface 260. In alternative embodiments, hard-wired circuitry may be used in place of or in combination with software instructions to implement processes consistent with the invention. Thus, implementations described herein are not limited to any specific combination of hardware circuitry and software.

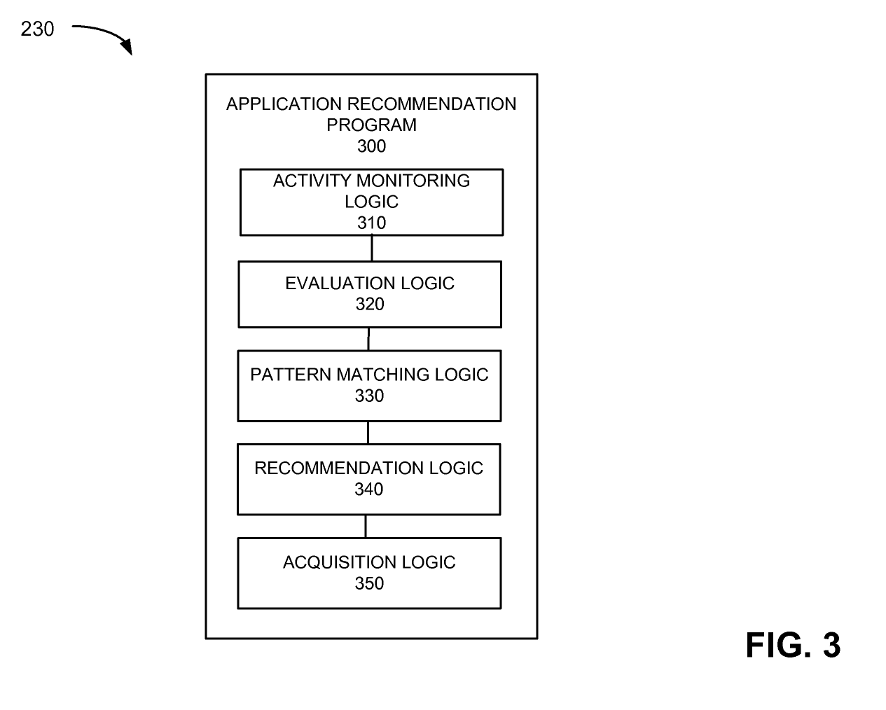

FIG. 3 is an exemplary block diagram of components implemented in user device 100 of FIG. 2. In an exemplary implementation, all or some of the components illustrated in FIG. 3 may be stored in memory 230. For example, referring to FIG. 3, memory 230 may include application recommendation program 300.

Application recommendation program 300 may include a software program executed by processor 220 that tracks a user's activity and provides recommendations to the user regarding applications that may be of interest to the user. In an exemplary implementation, application recommendation program 300 may include activity monitoring logic 310, evaluation logic 320, pattern matching logic 330, recommendation logic 340 and acquisition logic 350.

Activity monitoring logic 310 may include a graphical user interface (GUI) that allows a user to activate application recommendation program 300. For example, the GUI may be output to display 140 and allow the user to launch application recommendation program 300. In some implementations, the GUI may allow the user to indicate whether he/she would like to have application recommendation program 300 track particular types of activities or contexts for the user via sensors 270, while not tracking other types of activities or contexts for the user via other ones of sensors 270. As an example, the user may wish to track activities associated with the movement of user device 100 via an accelerometer or gyroscope, while not track activities associated with the context of the user, such as the location of user device 100. In this case, the GUI may allow the user to select tracking for movement, but elect to not track location or otherwise indicate that location tracking will not be performed.

Evaluation logic 320 may include logic for determining an activity which the user associated with user device 100 is performing. For example, evaluation logic 320 may receive information from activity monitoring logic 310 and determine an activity and/or a context associated with the user of user device 100. For example, based on a velocity in which user device 100 is moving, evaluation logic 320 may determine that the user is riding a bicycle, jogging, walking, etc.

In some implementations, evaluation logic 320 may detect particular motions/gestures that the user makes, and/or words spoken by the user to aid in identifying an activity. For example, if the user is holding the phone in his/her hand and a motion sensor included in sensors 270 indicates repetitive movement of the user's hand at a certain frequency, evaluation logic 320 may indicate that the user is jogging.

In some implementations, evaluation logic 320 may also use speech recognition to determine a user's activity or context. For example, user device 100 may include speech recognition software that can identify words voiced by a user or background voices. As an example, if the user is on a train, an announcement such as “this is a red line train to Washington, next stop . . . ,” may be provided on the train. Evaluation logic 320 may use speech recognition software to determine that the user is on a train, as well as the location of the user. As another example, the speech recognition software may identify words spoken by the user of user device 100, such “I am on Route 50, but I can't find the restaurant,” and determine that the user is driving and is lost on Route 50.

Pattern matching logic 330 may include logic used to determine whether movement of user device 100 matches one of a plurality of patterns stored in user device 100. For example, application recommendation program 300 may include pre-stored patterns associated with movement and/or position of user device 100 that correlate to defined activities. As an example, pattern matching logic 330 may store patterns associated with a user bicycling, jogging, walking, riding in a car, sitting at a desk, driving a car, riding in a train, riding in a bus, etc. These patterns may be stored based on predefined information gathered from actual user data gathered from a large number of users performing particular activities.

As an example, a large number of users (e.g., 100 or more) may be given a user device 100 and instructed to perform various activities, such as walking, driving a car, sitting at a desk, etc. All of the experimental data gathered from the users performing various activities may then be used to generate patterns for each particular activity. Application recommendation program 300 may store this information in a database of patterns in a memory (e.g., memory 230) associated with pattern matching logic 330. Pattern matching logic 330 may then compare real time movement and positional information of user device 100 to the database of patterns stored in application recommendation program 300 to determine whether the movement, positional information, etc., of user device 100 correspond to any of the stored patterns.

Recommendation logic 340 may include logic that identifies applications that may be of interest to the user of user device 100 based on, for example, the user's activity and context. For example, if evaluation logic 320 and/or pattern matching logic 330 determine that the user is riding a bicycle, recommendation logic 340 may determine that the user may be interested in a bicycle tour application associated with the area in which the user is currently riding. As another example, if evaluation logic 320 and/or pattern matching logic 330 determine that the user is riding in a train, recommendation logic 340 may determine that the user may be interested in a train schedule application that allows users to view train schedules and/or purchase train tickets. As still another example, if the user is driving in a car, recommendation logic 340 may determine that the user may be interested in a navigation application. As yet another example, if the user is running, recommendation logic 340 may determine that the user may be interested in a fitness application and/or a diet/calorie counting application. In another example, if the user is located in an airport terminal, recommendation logic 340 may determine that the user could be interested in an airline related application that provides departure/arrival schedules with gate information, or an application to pass the time, such as a word game application. As yet another example, if the user is surfing the Internet or playing a game, recommendation logic 340 may determine that the user may be interested in another game application related to the user's current Internet browsing or current game. In each case, recommendation logic 340 may analyze the user's current activity and/or context (e.g., the user's location) and provide a recommendation regarding one or more applications that may be of interest to the user at the current time, as described in more detail below.

In one implementation, recommendation logic 340 may periodically search various online venues or application stores (e.g., Google Play, Apple Store, etc.) that provide access to applications that may be downloaded and/or purchased by users. In an exemplary implementation, recommendation logic 340 may categorize the activity identified by evaluation logic 320 and/or pattern matching logic 330, compare the category of the user's current activity to the categories available via the application store, and provide a recommendation to the user of user device 100.

For example, recommendation logic 340 may categorize the user's activity as one of business, education, health and fitness, games, medical, maps/navigation, sports, transportation, travel, etc. This information may allow recommendation logic 340 to quickly identify applications that may be of interest to the user of user device 100 via the application store. For example, if evaluation logic 340 determines that the user is currently running, evaluation logic 340 may identify the category of health and fitness as being relevant to the user's current activity and provide a recommendation of an application from the health and fitness category.

Acquisition logic 350 may include logic for downloading or purchasing a particular application selected by the user of user device 100. For example, recommendation logic 340 may provide a recommendation for one or more applications to the user via display 140. If the user selects a particular application, acquisition logic 350 may interact with the website/application store to download the selected application. In some instances, acquisition logic 350 stores a user's credit card information or other payment information to allow the user to easily purchase the selected application without requiring the user to manually enter his/her credit card information or other information for each purchase.

The logic blocks illustrated in FIG. 3 are provided for simplicity. It should be understood that other configurations may be possible. It should also be understood that functions described as being performed by one program or logic block within a program may alternatively be performed by another program and/or another logic block. In addition, functions described as being performed by multiple logic blocks may alternatively be performed by a single logic block/device.

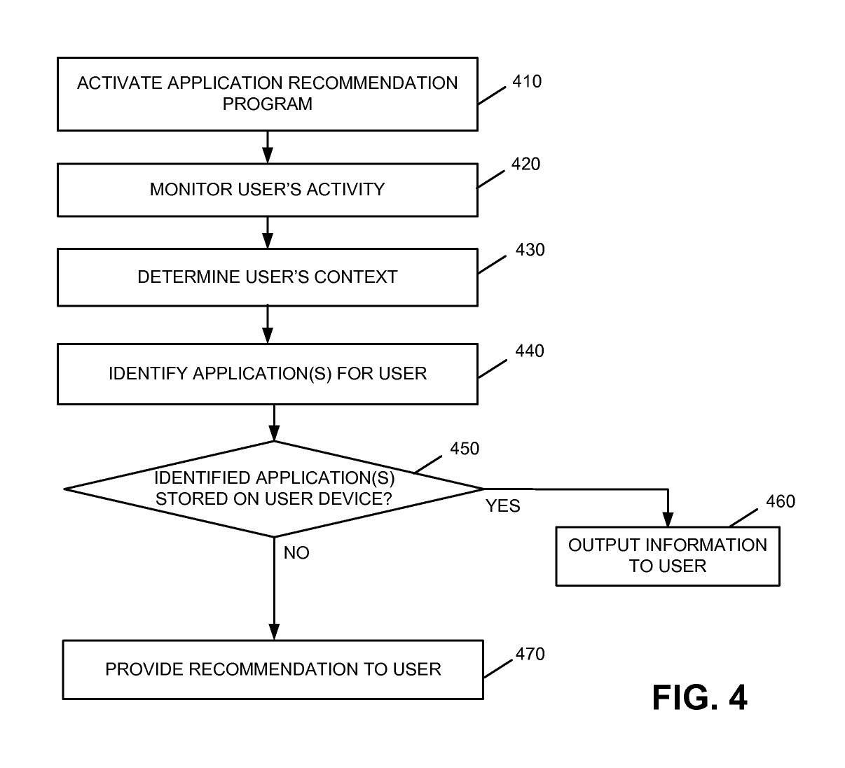

FIG. 4 illustrates exemplary processing associated with operating of application recommendation program 300. Processing may begin with a user of user device 100 accessing application recommendation program 300 (block 410). For example, a user of user device 100 may activate or execute application recommendation program 300 using one or more of control buttons, a GUI and/or an applications menu provided on display 140.

After application recommendation program 300 is activated, application recommendation program 300 may begin monitoring the user's activity (block 420). For example, assume that the user associated with user device 100 is driving a car. Evaluation logic 320 may receive information from a velocity sensor included in sensors 270 indicating that the user device 100 is traveling at 45 miles per hour (mph). Based on the 45 mph speed, as well as movements and positioning of the user detected by one of sensors 270, such as a gyroscope or an accelerometer that detects movement of the user's arms, a gyroscope or sensor that detects the user's orientation and/or posture (e.g., sitting), etc., evaluation logic 320 and/or pattern matching logic 330 may determine that the user is driving a car, as opposed to being a passenger in the car, or a passenger on a bus.

Evaluation logic 320 may also determine a context for user device 100 (block 430). For example, based on information provided by a GPS included in sensors 270, evaluation logic 320 may determine that the user is driving in Washington D.C. The context information may also include environmental parameters, such as the temperature, whether it is sunny or raining outside, the time of day, the day of week, etc. Recommendation logic 340 may receive the activity information (i.e., the user is driving a car) and the context information (e.g., the user in in Washington D.C.) and identify one or more applications that may be of interest to the user of user device 100 based on the current activity information and/or the context information (block 440).

Continuing with the example above in which the user is driving a car, recommendation logic 340 may determine that a navigation application may be of interest to the user. Recommendation logic 340 may also determine whether user device 100 already stores a navigation application (block 450). If user device 100 stores a navigation application (block 450—yes), recommendation logic 340 may output information via display 140 inquiring whether the user would like to launch the navigation application stored in user device 100 (block 460).

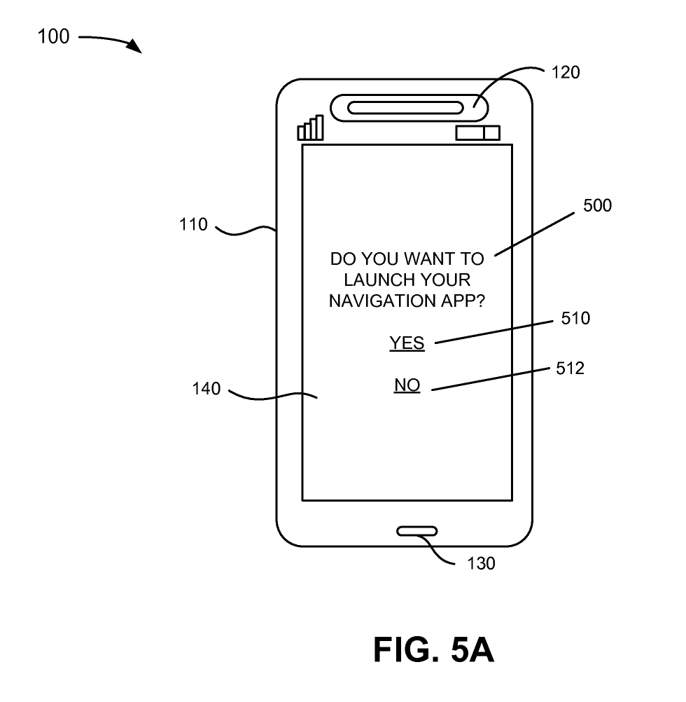

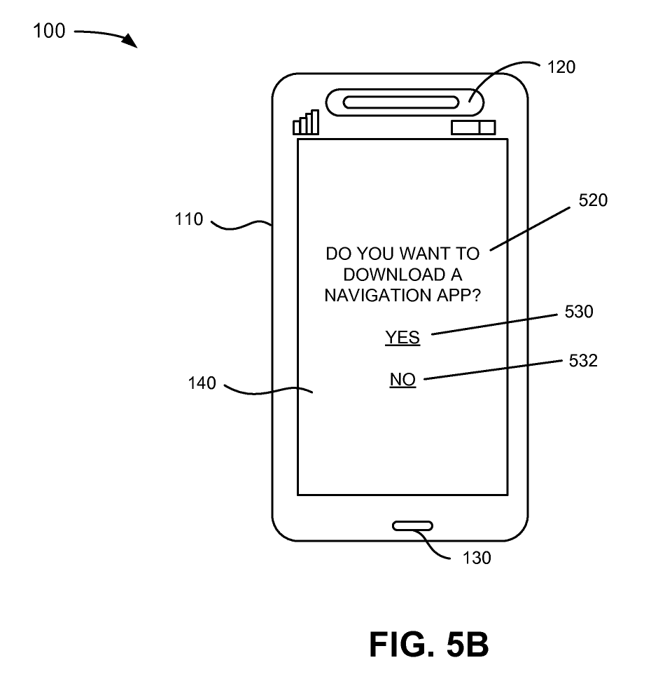

For example, recommendation logic 340 may output a message, such as “Do you want to launch your navigation app?”, as illustrated by message 500 in FIG. 5A. Recommendation logic 340 may also output a “yes” link 510 and a “no” link 512 associated with message 500. If the user selects yes link 510, or voices “yes,” use device 100 may automatically launch the navigation application stored in user device 100.

If a navigation application is not stored on user device 100 (block 450—no), recommendation logic 340 may inquire whether the user would like to download or purchase a navigation application (block 470). For example, recommendation logic 340 may output a message, such as “Would you like to download a navigation app?”, as illustrated by message 520 in FIG. 5B. Recommendation logic 340 may also output a “yes” link 530 and a “no” link 532 associated with message 520. If the user selects yes link 512, or voices “yes,” acquisition logic 350 may communicate with an application store to initiate the download and/or purchase of a navigation application.

For example, acquisition logic 350 may communicate with an application store and identify the subject matter “navigation” as a category or search query for identifying a particular application. Acquisition logic 350 may send the communication to the application store. The application store may receive the query from acquisition logic 350 and forward the cost of the application to user device 100, which may be output to display 140. The user may then decide to purchase/download the navigation application. Alternatively, acquisition logic 350 may have previously identified particular navigation/map applications from one or more application stores and provide the name of a most popular navigation application, as well as its cost, without having to contact an application store at the current time. In either case, the user may then decide to purchase/download the navigation application.

As discussed above, application recommendation program 300 may provide recommendations to a user based on a user's current activity and context. Application recommendation program 300 may also periodically search various application stores to identify applications in particular categories, as described in detail below.

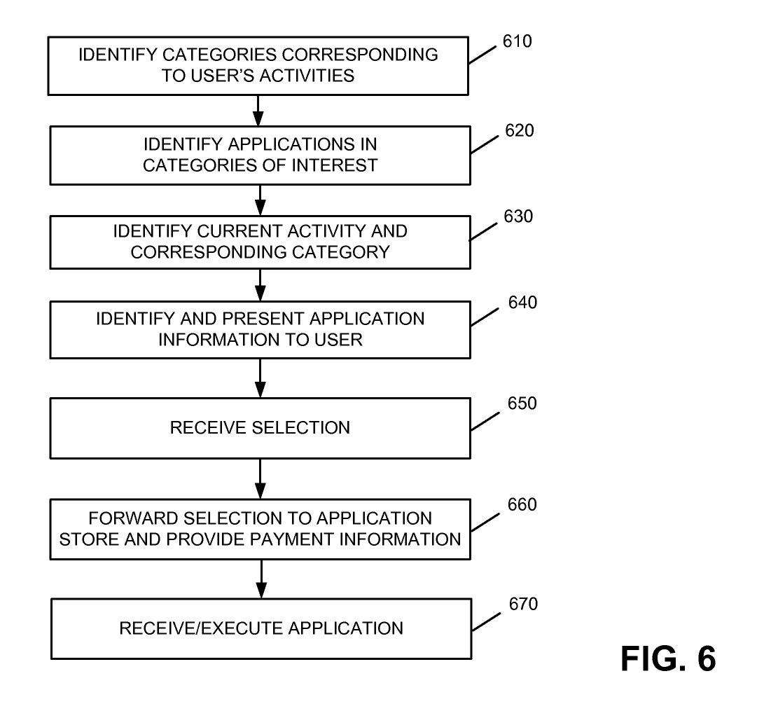

FIG. 6 illustrates exemplary processing associated with categorizing applications, providing recommendations to the user of user device 100 and acquiring selected applications. Processing may begin with recommendation logic 340 identifying various categories corresponding to the user's activities (block 610). For example, recommendation logic 340 may identify business, education, health and fitness, games, medical, maps/navigation, sports, transportation, travel, etc., as categories of interest to the user. In some instance, the user may interact with recommendation logic 340 via a GUI to select the categories of particular interest to the user.

Recommendation logic 340 may periodically access one or more application stores that provide applications (e.g., Google Play, Apple's App Store, etc.) to identify applications in the categories of interest (block 620). For example, recommendation logic 340 may query the application stores based on the categories of interest and identify particular applications stored in each category. As an example, recommendation logic 340 may identify the most popular application stored in each category, the cheapest application stored in each category, the highest rated application (based on consumer evaluations) stored in each category, etc. Since each category typically includes a large number of applications, recommendation logic 340 may also use key words or terms associated with applications in each identified category. For example, in the category of health and fitness, recommendation logic 340 may identify a most popular running application and store the name of the application, along with the term “running,” “jogging,” etc. Recommendation logic 340 may also identify a most popular bicycling application and store the name of the application with the terms “bike,” “biking,” “bicycle,” “bicycling”, etc. In this manner, recommendation logic 340 can continually update its listing of applications, including newly available applications, to identify applications that are most likely to be relevant to the user of user device 100 based on the user's current activity.

Recommendation logic 340 may also determine if the identified applications are already stored in user device 100. In this manner, recommendation logic 340 may store a list of applications that may be of interest to the user without having to contact the application stores at the time when the user is performing an activity.

Recommendation logic 340 may receive information identifying the user's current activity from evaluation logic 320 and/or pattern matching logic 330 (block 630). For example, assume that pattern matching logic 330 determines that the user is riding a bicycle. In this case, recommendation logic 340 may receive this information from pattern matching logic 330 and identify the health and fitness category corresponding to the user's current activity.

Recommendation logic 340 may then identify application(s) stored in the health and fitness category that may be of interest to the user (block 640). For example, recommendation logic 340 may search the health and fitness category for an application that includes the term “biking” or “bicycle” in its title and determine that an application with the term “biking” or “bicycle” may be of interest to the user.

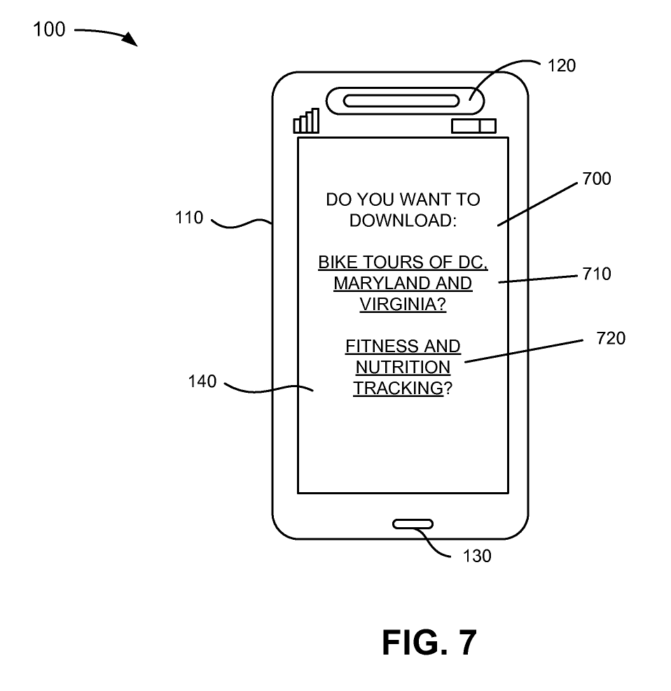

Recommendation logic 340 may also present the identified application(s) to the user via display 140 (block 640). Continuing with the example regarding bicycling, assume that recommendation logic 340 identifies two application that may be of interest to the user, such an application for bike tours of Washington D.C., Maryland and Virginia, and a calorie burning/nutrition tracking application. In this case, recommendation logic 340 may output a message, such as “Do you want to download “Bike Tours of DC, Maryland and Virginia?” “Fitness and Nutrition Tracking,” as illustrated by message 700 in FIG. 7. Recommendation logic 340 may also output links 710 and 720 associated with each of the identified applications.

If the user selects one of links 710 or 720, acquisition logic 350 receives the selection (block 650). Acquisition logic 350 may then forward a communication to the application store identifying the selected application, along with payment information (if the application is not free) (block 660). The application store receives the selection and downloads the application to user device 100. User device 100 receives the application and executes the application (block 670).

For example, in one implementation, user device 100 may automatically execute or launch the received application without further user input. In other instances, recommendation logic 340 may inquire whether the user would like to launch the application. In each case, an application that may be of interest to the user is provided based on the user's current activity and/or context. In this manner, user device 100 tracks various parameters via sensors 270 to identify a user's activity and context, identifies one or more applications that may be of interest to the user, determines if the identified applications are included in the user's stored applications, and provides a recommendation to the user.

### CONCLUSION

Implementations described herein provide a user with recommendations for applications based on a user's current activity and/or context. Such recommendations may provide the user with easy access to applications that may be of interest to the user, without having the user to manually search for applications. This may enhance the user's experience with respect to interacting with his/her mobile device.

The foregoing description of the embodiments described herein provides illustration and description, but is not intended to be exhaustive or to limit the invention to the precise form disclosed. Modifications and variations are possible in light of the above teachings or may be acquired from the practice of the invention.

For example, aspects have been described above with respect to identifying applications of interest based on a user's activity and/or context and determining whether the identified applications are already stored on user device 100. In other implementations, application recommendation program 300 may bypass determining if an identified application is already stored on user device 100 and merely present the identified application to the user.

In addition, although not described in the examples above, application recommendation program 300 may take into consideration the time of day, day of week, weather, etc., in providing recommendations to the user. As an example, if the current day is Saturday and the current weather conditions are rainy, application recommendation program 300 may provide a recommendation for a video game application, a word game/puzzle application, or a movie theater application listing current movies to the user. In such instances, secondary context information that may not be relevant to the user's current activity may be used to provide a recommendation that may be of interest to the user.

Still further, in some implementations, application recommendation program 300 may provide different tailored lists of applications to the user based on agreements with different application stores that provide applications, or based on agreements with particular service providers associated with providing cellular service to user device 100.

Further, implementations described above are directed to providing information identifying applications that may be of interest based on the user's current activity and/or context. In some implementations, other information could be provided to the user based on the user's activity and/or context. For example, information regarding the user's activity may be used to provide various news headlines, alerts or other information to the user. As an example, if the user frequently rides his/her bike, recommendation logic 340 may contact various news related websites and identify news stories associated with biking, such as an upcoming bike race (e.g., the Tour de France, a local bike race, etc.) that may be of particular interest to the user. The tailored information may then be provided to the user the next time the user browses the Internet, provided as an alert message, or provided in some other manner.

In addition, while series of acts have been described with respect to FIGS. 4 and 6, the order of the acts may be varied in other implementations consistent with the invention. Moreover, non-dependent acts may be performed in parallel.

It will also be apparent to one of ordinary skill in the art that aspects of the invention, as described above, may be implemented in computer devices, cellular communication devices/systems, media playing devices, methods, and/or computer program products. Accordingly, aspects of the present invention may be embodied in hardware and/or in software (including firmware, resident software, micro-code, etc.). Furthermore, aspects of the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an ASIC, an FPGA or other processing logic, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

The scope of the invention is defined by the claims and their equivalents.

What is claimed is:

1. A device, comprising:
a memory configured to store a first plurality of applications;
at least one sensor configured to:
detect information associated with an activity being performed by a user of the device; and
processing logic configured to:
receive the information from the at least one sensor,
identify the activity being performed by the user based on the received information,
identify at least one application based on the activity, and
output a message to the user identifying the at least one application.

2. The device of claim 1, wherein when detecting information, the at least one sensor is configured to:
detect information identifying at least one of movement, velocity, acceleration or orientation of the device, and
wherein the processing logic is configured to identify the activity being performed by the user based on the least one of the movement, velocity, acceleration or orientation.

3. The device of claim 1, wherein the processing logic is configured to:
access a website or application store that provides access to a second plurality of applications, and when identifying the at least one application, the processing logic is configured to:
identify the at least one application from the second plurality of applications.

4. The device of claim 1, wherein the processing logic is further configured to:
determine whether the at least one application is included in the first plurality of applications, and
output a link associated with executing the at least one application, in response to determining that the at least one application is included in the first plurality of applications.

5. The device of claim 1, wherein the processing logic is further configured to:
determine whether the at least one application is included in the first plurality of applications, and
output a link to a website or application store via which the at least one application is available, in response to determining that the at least one application is not included in the first plurality of applications.

6. The device of claim 1, wherein when identifying the activity being performed, the processing logic is configured to:
match the information received from the at least one sensor to a first one of a plurality of stored patterns, and
identify the activity corresponding to the first stored pattern.

7. The device of claim 1, wherein the processing logic is further configured to:
identify a first category corresponding to the activity and when identifying the at least one application, the processing logic is further configured to:
identify at least a first application in the first category.

8. The device of claim 1, wherein when identifying at least one application, the processing logic is configured to identify a plurality of applications.

9. The device of claim 1, wherein the at least one application comprises a first application, and the device further comprises:
user interface logic configured to:
receive a selection from the user corresponding to the first application, and wherein the processing logic is further configured to:
receive the selection from the user, and
automatically provide purchase information to a website offering the first application.

10. The device of claim 1, wherein the processing logic is further configured to:
identify context information associated with the device or the activity, and wherein when identifying the at least one application, the processing logic is configured to identify the at least one application based on the context information.

11. The device of claim 10, wherein the context information comprises at least one of a location of the device, a time of day, day of the week, or an environmental parameter associated with the device.

12. The device of claim 1, further comprising:
a touch screen display configured to display the message, wherein the message includes information inquiring whether the user would like to execute or download the at least one application.

13. The device of claim 1, wherein the activity comprises a physical activity performed by the user.

14. The device of claim 1, wherein the device comprises a mobile terminal.

15. A method comprising:
detecting, by at least one sensor, information associated with an activity being performed by a user of a mobile device;
receiving the information from the at least one sensor;
identifying the activity being performed by the user based on the received information;
identifying at least one application based on the activity; and
outputting a message to the user identifying the at least one application.

16. The method of claim 15, wherein the detecting information comprises:
detecting information identifying at least one of movement, velocity, acceleration or orientation of the mobile device, and
wherein identifying the activity comprises:
identifying the activity being performed by the user based on the least one of the movement, velocity, acceleration or orientation of the mobile device.

17. A non-transitory computer-readable medium having stored thereon sequences of instructions which, when executed by at least one processor, cause the at least one processor to:
receive, from at least one sensor, information associated with an activity being performed by a user of a device;
identify the activity being performed by the user based on the received information;
identify at least one application based on the activity; and
output a message to the user identifying the at least one application.

18. The non-transitory computer-readable medium of claim 17, wherein the information comprises at least one of movement, velocity, acceleration or orientation of the device, and wherein the instructions further cause the at least one processor to:
access a website or application store that provides access to a plurality of applications, and when identifying the at least one application, the instructions cause the at least one processor to:
identify the at least one application from the plurality of applications.

19. The non-transitory computer-readable medium of claim 17, wherein the received information comprises at least one of movement, velocity, acceleration or orientation of the device, and wherein the instructions to identify the activity cause the at least one processor to:
identify the activity being performed by the user based on the least one of the movement, velocity, acceleration or orientation of the mobile device.

20. The non-transitory computer-readable medium of claim 17, further including instructions for causing the at least one processor to:
identify context information associated with the device or the activity, and
wherein when identifying the at least one application, the instructions cause the at least once processor to identify the at least one application based on the context information.
